(19) United States
(12) Patent Application Publication
(10) Pub. No.: US 2024/0025710 A1
(43) Pub. Date: Jan. 25, 2024

(54) SUPPORT APPARATUS

(71) Applicant: Michael Philip HARPER, Suffolk (GB)

(72) Inventor: Michael Philip HARPER, Suffolk (GB)

(21) Appl. No.: 18/023,743

(22) PCT Filed: Aug. 27, 2021
(86) PCT No.: PCT/GB2021/052235

§ 371 Date: Feb. 28, 2023

(30) Foreign Application Priority Data
Aug. 28, 2020 (GB) 2013567.9

(51) Int. Cl. B66C 23/48

(52) U.S. Cl. CPC B66C 23/485

(57) ABSTRACT

A frame to assist in removing parts from a vehicle is disclosed. The frame comprises a pivot mount, adapted to be pivotally mounted to a base; a suspension means and a connection bar linking the suspension means and the base in fixed spatial arrangement. A generally convex shape for the connection bar enables an object to be freely suspended from the suspension means such that an object can rotate about an imaginary line joining the suspension means to the base.

Also disclosed is a method of removing a part such as a gearbox from a vehicle utilising the above frame.

### FIELD OF THE INVENTION

The present invention relates to a support device to support and manoeuvre a vehicle part such as a gear box, and can be used in particular by an operator working beneath a vehicle. The vehicle can be a car, a van, a lorry or the like.

### BACKGROUND TO THE INVENTION

Although many repairs to vehicles can be made relatively simply, dealing with problems with larger parts can often be problematic, particularly when the part is bulky and/or heavy. In modern vehicles, the utilisation of space within the motor and also the drive assembly is now such that there is relatively little space in which an operator can carry out work on damaged parts. Manufacturers have a commercial drive to maximise the space provided for the car users and for storage space within the car. When a part needs to be removed therefore, either for replacement or repair, the operator is left with the problem of how to safely deal with that removal.

The problem is exacerbated when dealing with heavy parts such as a gearbox. A typical gearbox is too heavy for an operator to safely support by themselves, even under ideal working conditions. However, conditions are normally far from ideal as an operator is, firstly, working beneath a vehicle, usually in a pit or with the vehicle on a ramp. Secondly, once a gearbox is disconnected from the vehicle, the gearbox needs to be rotated about one or more axes in order to be able to be brought through the openings available in the vehicle chassis.

To this end, mechanical supports are available which in their most basic form provide a raisable platform which is brought from beneath the gearbox into supporting contact with the gearbox. Once the gearbox is fully disconnected from the vehicle, the platform is then lowered, bringing the gearbox down and out of the vehicle. The platform usually has wheels enabling the gearbox to be moved to a more convenient location. However, there remains the problem should the gearbox need to be rotated before removal, especially as the platform provides an additional hindrance to an operator in reaching the gearbox to turn it.

It is an object of the current invention, to provide an apparatus to address the above problems.

It is a further object of the invention to provide a method of removing a gearbox from a vehicle.

### SUMMARY OF THE INVENTION

According to a first aspect of the invention there is provided a frame to assist in removing parts from a vehicle, the frame comprising;
a pivot mount, adapted to be pivotally mounted to a base;
a suspension means operably connected to a first end of a connection bar (12-14), the connection bar linked at a second end to the pivot mount and linking the suspension means and the pivot mount in fixed spatial arrangement;
the connection bar having a generally convex shape enabling an object to be freely suspended from the suspension means such that an object can rotate about an imaginary line joining the suspension means to a base.

The arrangement enables an object to be first supported by the apparatus whilst in one orientation and easily moved to another orientation without being detached from the apparatus.

The connection bar preferably includes an end section, horizontally deployed at right angles to the pivot mount.

Optionally, the shape of the connection bar describes a semi-circle to provide maximum clearance from a supported object.

Preferably the suspension means comprises a rod, seated in a throughaperture in the connection bar and secured in position by a securing member, further preferably in screw-threaded connection with a first end of the rod, and yet further preferably, the securing member is separated from the connection bar by one or more friction reducing members to enable the rod to pivot about an axis parallel to the throughaperture.

The axis of the rod is preferably directed towards the connection between the pivot mount and the base to ensure that a supported object hangs substantially over the centre of gravity of the frame.

Preferably, an eyelet having throughapertures, the throughapertures being further preferably elongate, is secured to the second end of the rod to enable securing means such as straps to be secured thereto.

The suspension means preferably comprises an eyelet, comprising elongate apertures through which one or more straps are passable. The eyelet is preferably rotatably secured to the connection bar, and further preferably to the end section of the connection bar.

Preferably, the first end of the connection bar or the end section thereof comprises a narrow portion of smaller diameter than the rest of the connection bar or end section. Further preferably, the first end of the connection bar includes an end cap of greater diameter than the narrow portion. Yet further preferably, the end cap is removably securable to the connection bar.

According to a second aspect of the invention there is provided a method of removing a part such as a gearbox from a vehicle, the method including the steps of:
selecting a base and pivotally securing a frame thereto;
the frame comprising;
a pivot mount, adapted to be pivotally mounted to a base;
a suspension means and a connection bar linking the suspension means and the base in fixed spatial arrangement;
operably attaching flexible straps to the suspension means;
the connection bar having a generally convex shape enabling an object to be freely suspended from the suspension means such that an object can rotate about an imaginary line joining the suspension means to the base;
manoeuvring the frame beneath a vehicle, raising the frame and pivoting the frame such that a part is within the convex shape of the connection bar;
securing straps about a part to enable the straps to support a part;
decoupling a part from a vehicle and manoeuvring a part and lowering the frame until a part is clear of a vehicle.

The part can thus be removed with minimal support of the weight of the part by the operator being required.

### BRIEF DESCRIPTION OF THE DRAWINGS

The invention is now described with reference to the accompanying drawings which show by way of example only, one embodiment of a support. In the drawings:

FIG. 1a is a front elevation of a first embodiment of a support;

FIG. 1b is a rear elevation of the support of FIG. 1a;

FIG. 1c is an underside view of the support of FIG. 1a;

FIG. 1d is a plan view of the support of FIG. 1a;

FIG. 1e is a detailed view of the region A of FIG. 1a;

FIG. 1f is a detailed view of the region B of FIG. 1b;

FIG. 1g is a is a detailed view of the region C of FIG. 1c;

FIGS. 2a-2d are perspective views of the first embodiment of support;

FIG. 3 is an exploded perspective view of the region of FIG. 1e;

FIG. 4 is a perspective view of the region of FIG. 1e;

FIG. 5 is a perspective view of the base region of a support;

FIG. 6 is a perspective view of a second embodiment of a support;

FIG. 7 is a perspective view of a third embodiment of a support;

FIG. 8 is a side view of a gearbox supported by the first embodiment of support;

FIG. 9 is an end view of a gearbox supported by the first embodiment of support;

FIGS. 10a-10d Illustrate first and second side views of a second embodiment of support, a close-up view of area A of FIG. 10a, and a close-up view of area B of FIG. 10b;

FIG. 11 illustrates an extendable tubular element of a support stand;

FIG. 12 illustrates a secured extendable element of FIG. 11;

FIG. 13 illustrates a strap retainer in an alternative embodiment of crossbar with a first support clip;

FIG. 14 illustrates the alternative crossbar of FIG. 13 with a second support clip;

FIG. 15 illustrates the alternative crossbar of FIG. 13 with an embodiment of lifting strap;

and

FIG. 16 illustrates an alternative embodiment of a retainer in which a strap or the like can be secured.

### DETAILED DESCRIPTION OF THE INVENTION

Turning to the Figures, these show an embodiment of a support apparatus which is in accordance with the present invention and which is particularly suitable when removing or installing a gearbox from or into a motorised vehicle. Exemplary dimensions are provided, although the skilled person will recognise that the dimensions are illustrative only and other dimensions can be used where applicable.

In the Figures, a support, generally referenced 10, is illustrated. The support 10 is primarily formed of a strong, rigid material such as steel, although other materials known in the art can be employed. The support is intended to be pivotally attached, either permanently, or more preferably, releasably, to a base (not illustrated) which holds the support 10 in an upright position and acts to prevent the support 10 from toppling over, particularly when supporting a gearbox. The base can itself be supported on wheels allowing the support and a gearbox to be moved to another location and also for a new or repaired gearbox to be brought to the vehicle for installation.

In order to support the mass of a gearbox, the support 10 is provided with a frame comprising tubular segments 12-15. The tubular segments 12-15 have a circular cross-section and are around 38 mm in diameter. Although the frame is described as having sections, it should be noted that the frame is preferably formed of a single piece of polyethylene-coated tubular steel bent into the configuration shown. Extending from a first end of the tubular segment 12, around 235 mm in length, is a pivot mount 11, about 90 mm in length and again formed of tubular steel of 38 mm diameter. The pivot mount 11 and the frame are secured together by a conventional weld. In use, the pivot mount 11 fits about a cylindrical rod extending from the base, allowing the pivot mount 11 to pivot freely 360° in either rotational direction about the tube axis. In a preferred embodiment, the frame is provided with releasable securing means enabling an operator to secure the pivot mount, and thus the frame in a particular orientation to prevent pivoting when such is undesirable.

The tubular segment 13 is parallel to the pivot mount 11 and in use forms an upright. The tubular segment 13 has a length of around 380 mm and is joined at a first end to the second end of the tubular segment 12, the angle between the 2 segments being 120°. To provide additional strength to the support 10, a reinforcement member 26 is welded to the pivot mount 11 and the tubular segment 12.

Extending from the second end of the tubular segment 13 is a further tubular segment 14, around 150 mm in length, with the 2 segments 13, 14 at 120° to each other. Depending from the other end of the tubular segment 14 is a tubular segment functioning as a crossbar 15, approximately 120 mm in length. The crossbar 15 is joined to the other end of the tubular segment 14 by a connecting segment 25, and forms an angle of 150° with the tubular segment 14. The crossbar 15 in the illustrated embodiment is therefore so deployed as to be at a right angle to the axis of the pivot mount 11.

It will be seen that the tubular segments 12-14 and the crossbar 15 together form a generally convex shape. This allows an object to be more easily suspended and manoeuvred into position without impacting against the frame. Other shapes of frame can be devised by a person skilled in the art, such as V-shaped, open-rectangular, or an arc of a circle or ellipse, but retaining the generally convex shape.

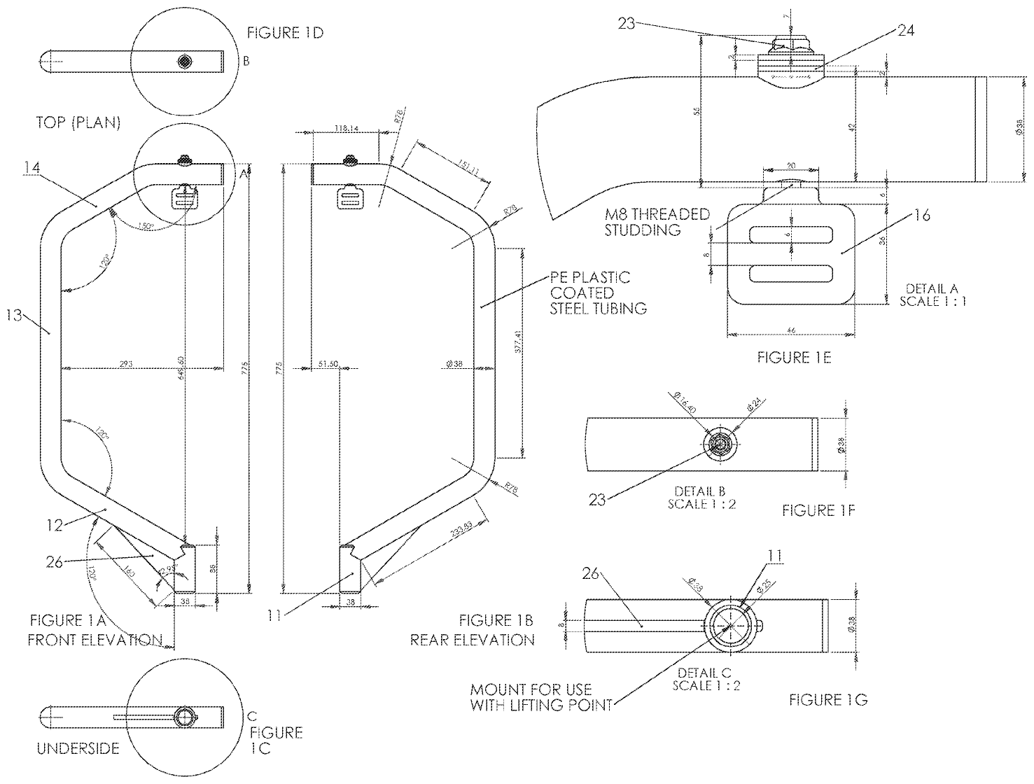

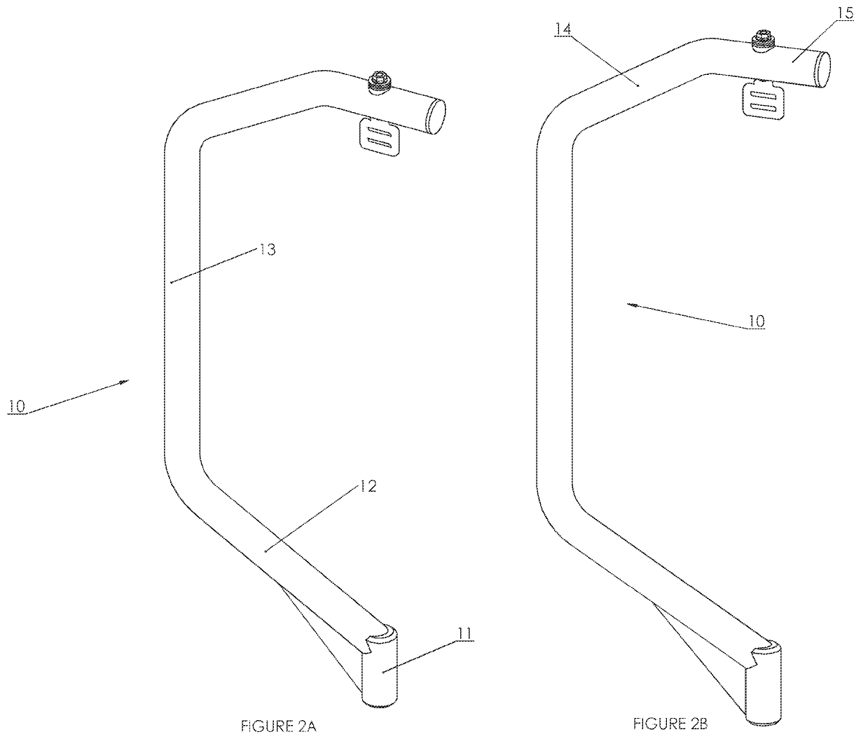

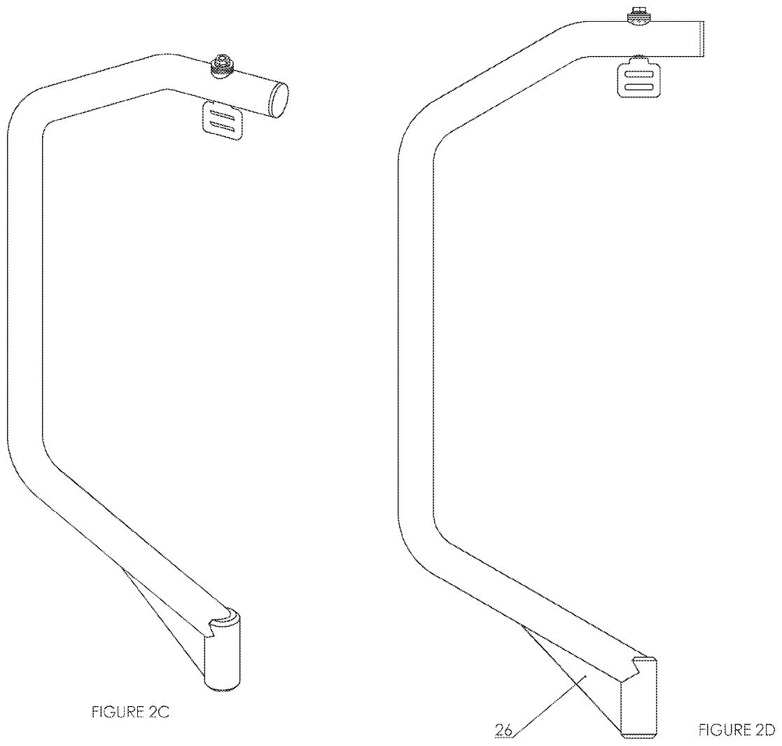

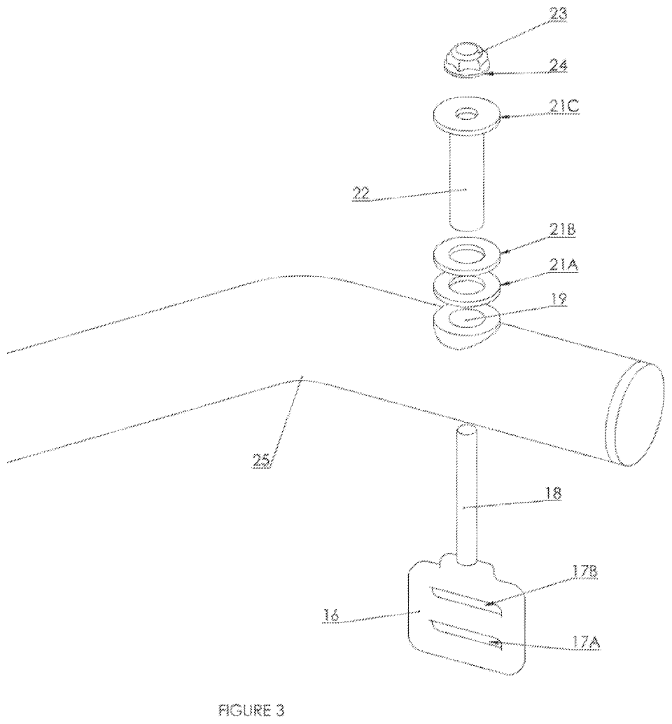

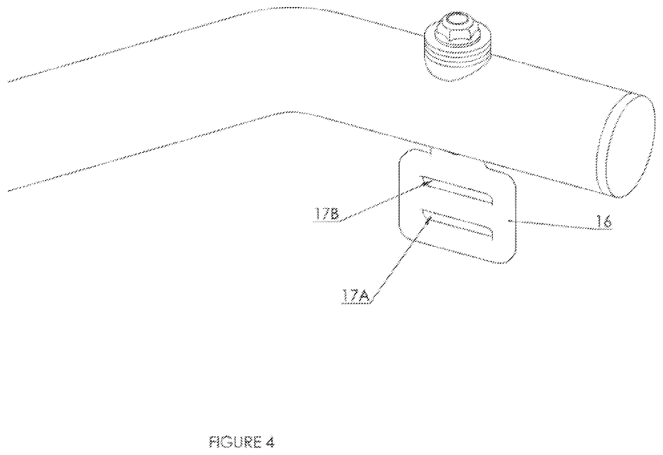

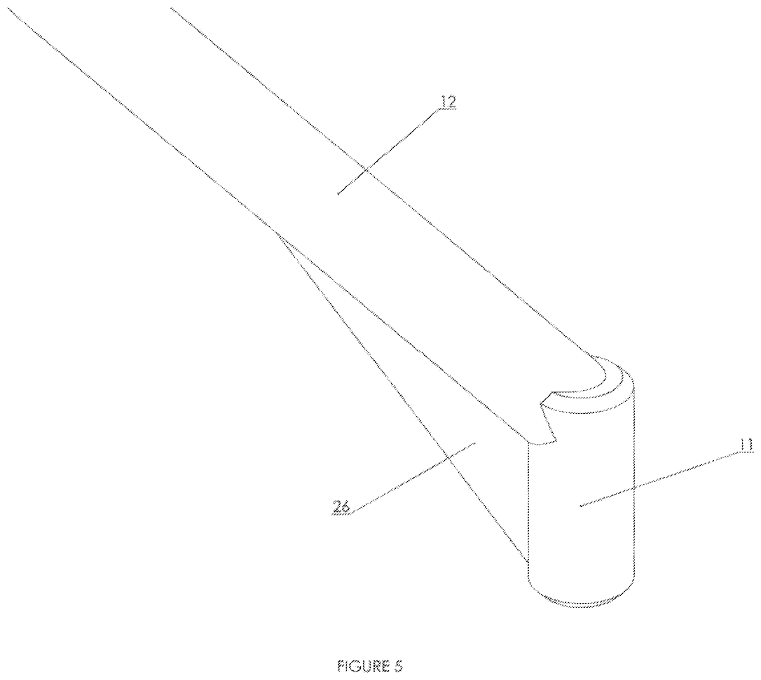

The support 10 provides a means by which an object can be suspended, and the supporting means is included as part of the crossbar 15. Referring again to FIG. 1, and also additionally to FIGS. 3 and 4, these illustrate a preferred means of supporting an object. The support illustrated allows an object to be readily secured in position by means of one or more flexible straps (not illustrated) of a type known in the art. The strap particularly contemplated is of a synthetic fibrous material which resists tears and stretching. Moreover, the material of a strap is such that two sections of strap in contiguous contact with each other resist movement due to the frictional force generated on relative motion.

To retain one or more straps, an eyelet 16 is provided, generally rectangular of dimensions of approximately 35 mm×45 mm, depending downwardly from the crossbar 15. The eyelet 16 has elongate rectangular apertures 17a, 17b through which at least one section of a strap can pass. Again, the engagement of a strap with the walls of an aperture 17a, 17b resists movement of a strap through that aperture so securing an object being suspended by a strap.

The eyelet 16 has a small tab from which extends a rod 18 threaded, at least at a first end, to threadably receive a securing nut 23. The rod 18 is housed for free rotation within a throughaperture 19 in the crossbar 15. Further, the orientation of the rod 18 is stabilised within the crossbar 15 by means of a sleeve 20, housed within the throughaperture 19, which sleeve 22 prevents the rod 18 from deviating too far from a substantially vertical in-use position. The sleeve 22 has at one end a flange 21c, securely fixed thereto by a weld joint. The flange 21c prevents the sleeve 22 from falling out of the throughaperture 19 by resting on the upper edge of the throughaperture 19. Prior to insertion of the sleeve 22 into the throughaperture 19 washers 21a, 21b are slid over the outside of the sleeve 20. When the securing nut 23 is threaded onto the end of the rod 18 the washers 21a, 21b separate the flange 21c from the upper edge and facilitate the rotation of the rod 18. The washers 21a, 21b can be formed of a steel material which can optionally be coated with a low friction material such as Teflon™. Alternatively, the washers 21a, 21b can be formed of a low friction material.

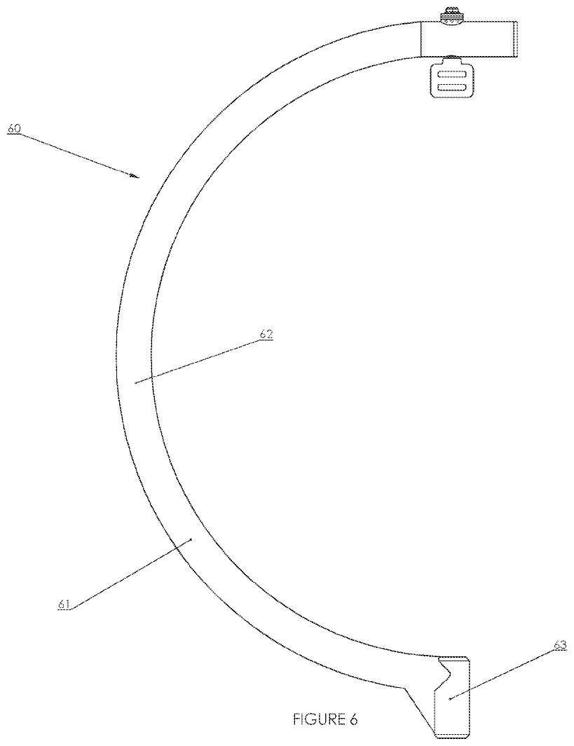

In FIG. 6 is illustrated a second embodiment of support apparatus in which the support 60 comprises a frame which includes a tubular support 61, generally formed into a semi-circular configuration. The support is formed of a polyethylene steel tube of diameter 38 mm. The radius described by the surface 62 of the support 60 is around 325 mm. A reinforcement member 66 is welded to the pivot mount 63 and the tubular section 61.

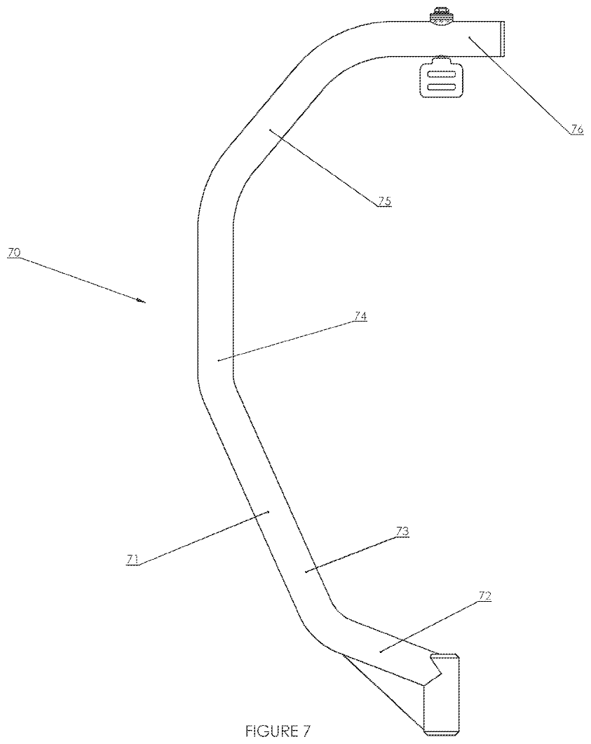

In FIG. 7 is illustrated a third embodiment of support apparatus having a support 70 which comprises a frame including a tubular segment 71. The support 70 is again formed of a polyethylene steel tube of diameter 38 mm. The support 70 is bent into 5 straight segments 72-76. The angles between neighbouring segments, starting with the lowermost segment 72, are 135°, 156°, 140°, and 130° respectively. In both the second and the third embodiments of frame, the supporting means is as described in the first embodiment.

In use therefore, when an operator wishes to, for example, remove a gearbox from a vehicle, the operator positions the vehicle so that an operator can work safely beneath the vehicle, for example on a ramp or above a work-pit. The undertray and other components causing a hindrance to access the gearbox are removed.

If required and provided suitable securing means are present, the orientation of the frame relative to the base can be releasably fixed. One or more flexible straps are placed though the apertures 17a, 17b of the eyelet 16. The straps are incorporated into a ratcheting system which enables the straps to be tightened or released when securing or releasing an object being moved. The base is positioned beneath the vehicle from which the gearbox is to be removed, and the base raised to allow the frame to pass into space within the vehicle chassis.

Once in the chassis, the frame is rotated in position such that the gearbox lies in the concave space within the frame section 12-14 and the crossbar 15, and between the eyelet 16 and the pivot mount 11. The eyelet is further positioned so that it is above the gearbox with the straps to either side of the gearbox. The straps are passed about the gearbox and tightened using the ratcheting system to enable the gearbox, once decoupled from the vehicle, to be supported in a balanced fashion by the straps. The operator selects a suitable base and secures a frame thereto by placing the pivot mount 11 about a cylindrical rod extending from the base. The height of the frame is raised so that some of the weight of the gearbox is borne by the straps.

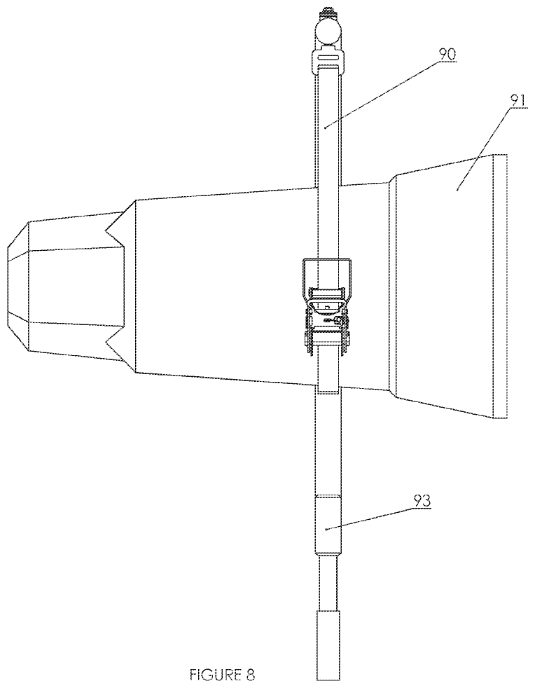

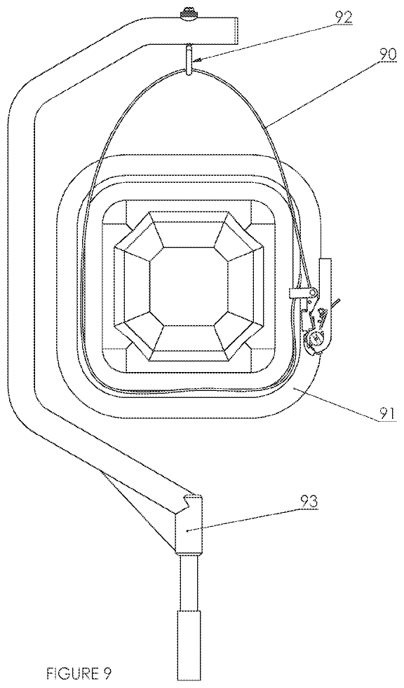

FIGS. 8 and 9 illustrate support of a gearbox in which straps 90 have been secured about a gearbox 91. If deemed required by an operator, further sets of straps can be utilised to make the gearbox 91 secure. It will be noted that the positioning of the eyelet 92 is such that the centre of gravity of the gearbox 91 lies substantially along an imaginary line joining the eyelet 92 and the pivot mount 93. In addition to straps, chains, ropes or the like or combinations thereof can be utilised in the lifting operation.

In more detail, the car is raised up and any undertray or other component removed to allow access to the gear box. The support apparatus is manoeuvred into place, so that the eyelet is above the gearbox with the straps to either side of the gearbox. The straps are secured into position around the gearbox to ensure the gearbox remains balanced. Should a vertical lift device not be in position, then this is connected to the support device to enable the support device to be moved in a vertical direction. The lift device is then adjusted so that support is provided to the gearbox via the straps. The fixings connecting the gearbox to the car can then be removed. The gearbox is thus decoupled from the vehicle, so that its weight is borne by the straps and the frame. If secured, the frame can be released to enable the frame to pivot should this be required to allow the gearbox and the frame to exit the chassis. The gearbox can now be manipulated, by rotation about 3 mutually perpendicular axes to allow the gearbox to be manoeuvred into an orientation and position enabling the gearbox to be removed. Once the gearbox is in a suitable position, the base is lowered until the gearbox is clear of the chassis and then moved to where the gearbox is required. During this operation the weight which needs to be borne by an operator is far less than would normally be the case. Moreover, there is no need for an operator to be beneath the gearbox. The risk of injury to an operator is therefore far less.

To install a gearbox, again the vehicle is raised on a ramp or above a work-pit. The frame is secured to a base and the gearbox retained within one or more straps coupled to the frame in the same manner as described above. The gearbox is positioned beneath the vehicle and then raised into position with an operator rotating the gearbox within the straps to facilitate the installation in the correct position. The gearbox is secured to the vehicle. The straps are loosened and removed, following which the base is separated from the frame and moved clear of the vehicle. The frame is removed from the vehicle's interior and any remaining work carried out before refitment of the undertray.

In an alternative mode of use, for example to aid in carrying out work on the suspension of a car, the support apparatus can be used to exert an upward force on a spring or other element of the suspension system. This can be used to separate components of the system from each other. For example straps can be attached to one component, which straps are secured to the vertical lift device. Further straps are attached to another component, which further straps are secured to the support apparatus. On lifting the support apparatus, the two components are thereby separated from each other.

In a further, non-illustrated embodiment, two support apparatuses can be secured, one atop the other to provide two degrees of freedom to support separate objects and allow their individual manoeuvring.

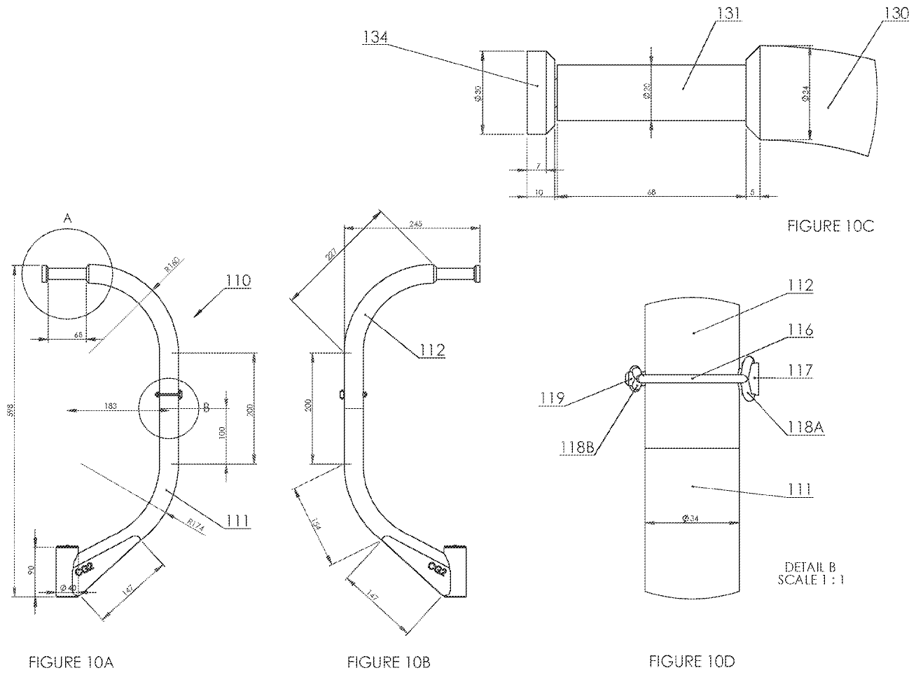

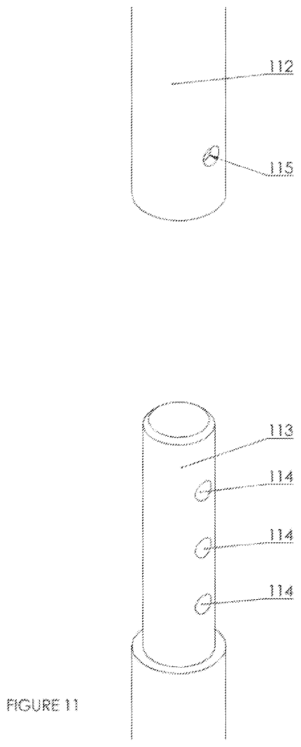

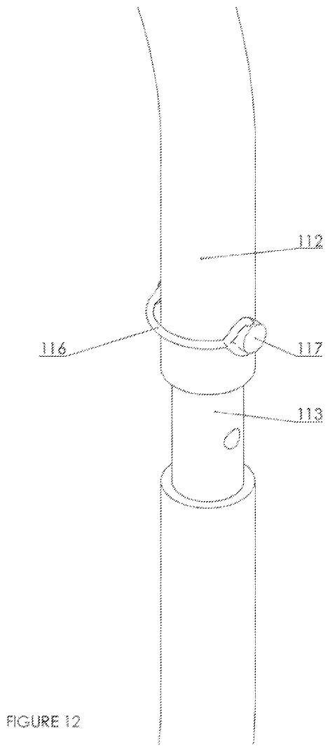

FIGS. 10 and 11 illustrates an alternative tubular element 110 which can be extended or retracted to suit the use. The element 110 comprises two segments 111, 112. The element 111 has an end portion 113 which is of smaller diameter than the rest of the segment 111, with the outer diameter of the end portion 113 matching that of the inner diameter of the element 112. The end portion 113 comprises a series of apertures 114. In use, as shown in FIG. 12, one of the apertures 114 can be aligned with the aperture 115 in the element 112 and the relative positions of the elements 111, 112 fixed using a suitable securing clip 116. The clip 116 has a loop 118a which passes about the head of a pin 117 which itself passes through both of the apertures 114, 115 to prevent axial movement of the elements 111, 112. A further loop 118b on the clip 116 similarly passes about the end 119 of the pin 117, which passes through corresponding apertures on the opposite side of the elements 111, 112.

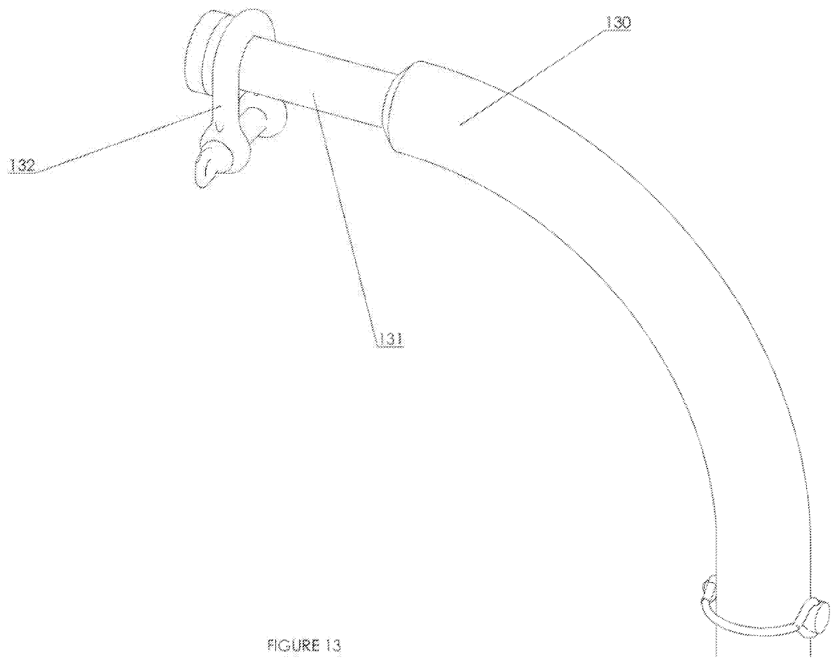

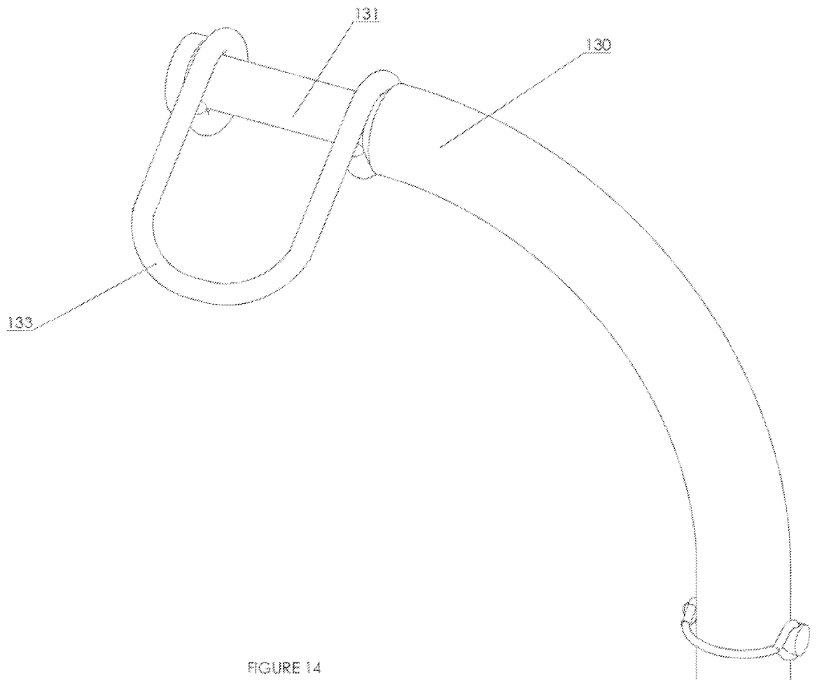

In the embodiment of crossbar 130 shown in FIG. 10 and also in FIGS. 13 and 14, the end portion 131 of the crossbar 130 is of thinner diameter than the rest of the crossbar 130. This provides for a clip such as that shown as 132 in FIGS. 13 and 133 in FIG. 14 to be attached to aid the securing of further elements such as straps, or alternatively for a strap to be fitted about the thinner portion 131. There is thus less risk of the clip slipping from the crossbar 130. In an option, the end-piece 134 is removably fixable to the crossbar 130 to facilitate fitment of a clip.

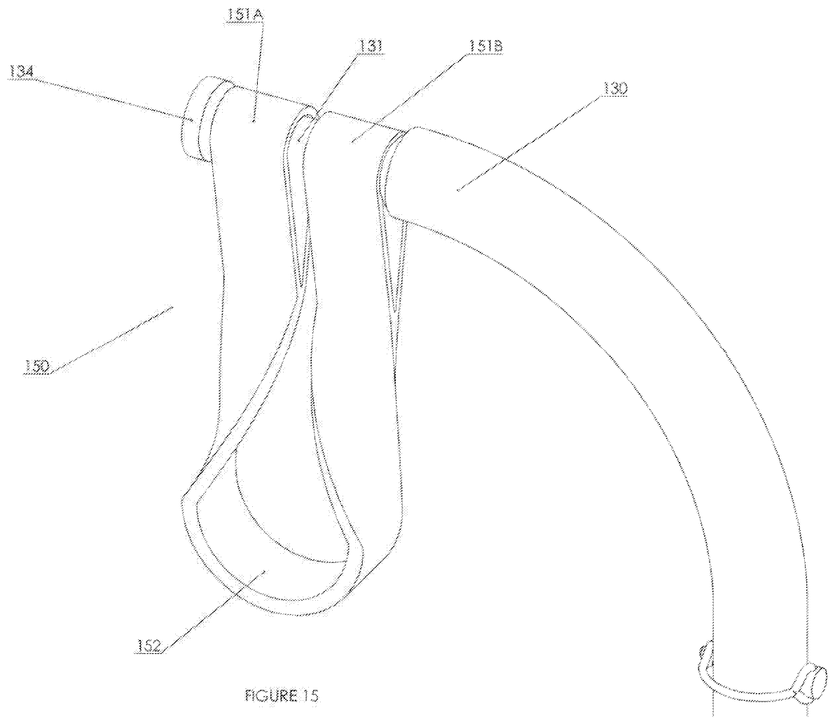

In the embodiment of FIG. 15, a strap 150 has a loop 151a, 151b at each end, which loops are passed over the end portion 131 of the crossbar 130. Where the size of a loop is smaller than the diameter of the end-piece 134, then the end-piece 134 is removed to allow placement of the strap 150, and then secured in position on the crossbar once placement has taken place. An item to be lifted can then be secured to the central portion 152 of the strap 150. In a further embodiment, not illustrated, a variable length strap can be used to suit the particular use.

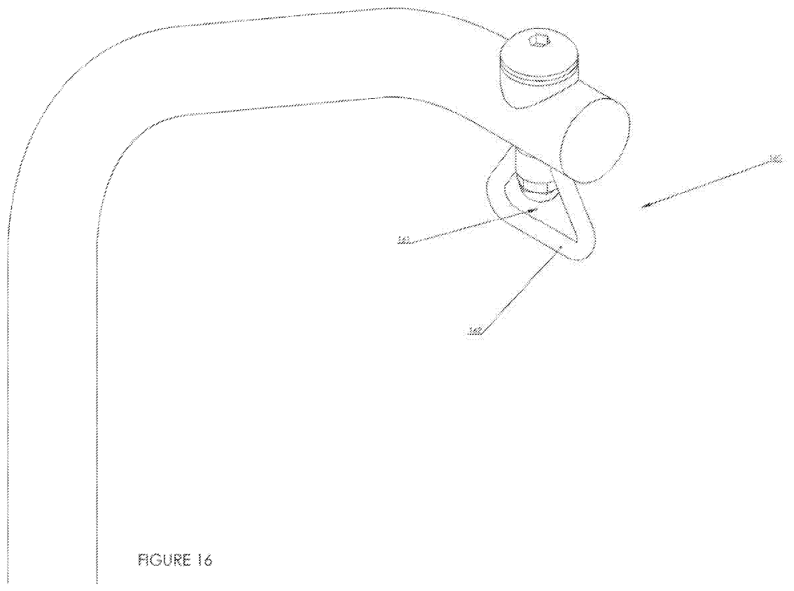

In FIG. 16 an alternative embodiment of retainer in which a strap or the like can be secured for use in lifting objects such as a gear box. The retainer 160 in this embodiment has a generally triangular shape, defining an aperture 161 through which a strap can pass, and is deployed with one of the sides 162 of the triangle in a horizontal orientation to aid in the stability of a strap secured therethrough.

1. A frame to assist in removing parts from a vehicle, the frame comprising;
a pivot mount (11), adapted to be pivotally mounted to a base;
a suspension means operably connected to a first end of a connection bar (12-14), the connection bar linked at a second end to the pivot mount and linking the suspension means and the pivot mount in fixed spatial arrangement;
the connection bar (12-14) having a generally convex shape enabling an object to be freely suspended from the suspension means such that an object can rotate about an imaginary line joining the suspension means to a base.

2. The frame according to claim 1, wherein the connection bar includes an end section (15), horizontally deployed at right angles to the pivot mount.

3. The frame according to claim 1, wherein the shape of the connection bar describes a semi-circle to provide maximum clearance from a supported object.

4. The frame according to claim 1, wherein the suspension means comprises a rod (18), seated in a throughaperture (19) in the connection bar and secured in position by a securing member (23).

5. The frame according to claim 4, wherein the securing member is in screw-threaded connection with a first end of the rod.

6. The frame according to claim 4, wherein the securing member is separated from the connection bar by one or more friction reducing members (21a-c) to enable the rod to pivot about an axis parallel to the throughaperture.

7. The frame according to claim 4, wherein the axis of the rod is directed towards the connection between the pivot mount and the base to ensure that a supported object hangs substantially over the centre of gravity of the frame.

8. The frame according to claim 4, including an eyelet having throughapertures secured to the second end of the rod.

9. The frame according to claim 8, wherein at least one throughaperture is elongate.

10. The frame according to claim 1, wherein the suspension means comprises an eyelet, comprising elongate apertures.

11. The frame according to claim 10, wherein the eyelet is rotatably secured to the connection bar.

12. The frame according to claim 11, wherein the eyelet is secured to the end section of the connection bar.

13. The frame according to claim 1, wherein the first end of the connection bar or the end section thereof comprises a narrow portion (131) of smaller diameter than the rest of the connection bar or end section.

14. The frame according to claim 13, wherein the first end of the connection bar includes an end cap of greater diameter than the narrow portion (131).

15. The frame according to claim 14, wherein the end cap is removably securable to the connection bar.

16. A method of removing a part such as a gearbox from a vehicle, the method including the steps of:
selecting a base and pivotally securing a frame thereto;
the frame comprising;
a pivot mount, adapted to be pivotally mounted to a base;
a suspension means and a connection bar linking the suspension means and the base in fixed spatial arrangement;
operably attaching flexible straps to the suspension means;
the connection bar having a generally convex shape enabling an object to be freely suspended from the suspension means such that an object can rotate about an imaginary line joining the suspension means to the base;
manoeuvring the frame beneath a vehicle, raising the frame and pivoting the frame such that a part is within the convex shape of the connection bar;
securing straps about a part to enable the straps to support a part;
decoupling a part from a vehicle and manoeuvring a part and lowering the frame until a part is clear of a vehicle.
